(19) United States
(12) Patent Application Publication
(10) Pub. No.: US 2010/0245930 A1
(43) Pub. Date: Sep. 30, 2010

(54) BANNER SHEET-BASED SAMPLING METHOD

(75) Inventors: Eric Gross, Rochester, NY (US); Charles A. Radulski, Macedon, NY (US); Palghat Ramesh, Pittsford, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: XEROX CORPORATION, Norwalk, CT (US)

(21) Appl. No.: 12/413,829

(22) Filed: Mar. 30, 2009

(51) Int. Cl. H04N 1/00

(52) U.S. Cl. 358/406

(57) ABSTRACT

The banner or cover sheet for a print job may be used for aperiodic sampling of transfer performance and/or fusing performance. Sensing pre-process and post-process is required. The resulting sampling is aperiodic and dependent on the job flow. In office products there is typically a frequent generation of cover sheets and the information collected in this way can be useful in system performance optimization. The concept is described for a tandem transfer system.

### BACKGROUND

The systems and methods disclosed herein are related to the art of image rendering devices such as printers and displays. Embodiments will be described in terms of laser-based electrophotographic marking engines, such as those used in printers, photocopiers and facsimile machines. However, embodiments are applicable to other rendering devices, such as those that present image data in raster lines including display devices and other kinds of printers.

By way of background, variations in paper properties have a major impact on transfer and fusing sub-system performance. It is often difficult to measure paper properties in-situ and doing so only implies an impact on performance based on previously generated models of behavior. The models of behavior are created by extensive open loop characterization and the creation of look up tables for parameter adjustment. Open loop adjustments based on paper weight and environmental conditions are typical. To first order, these approaches have resulted in performance improvements. However, they are all open loop and therefore suffer from the open loop “one size fits all” approach. Active feedback is desirable since it can compensate for disturbances through direct measurement. Printing diagnostic patches on customer images is not usually acceptable and using dedicated paper for generating a feedback signal results in additional paper cost and requires special handling schemes to remove the paper from the customer document.

Thus, the exemplary embodiments contemplate a new and improved method and apparatus that resolves the above-referenced difficulties and others.

### INCORPORATION BY REFERENCE

The following patents/applications, the disclosures of each being totally incorporated herein by reference, are mentioned:

U.S. patent application Ser. No. 12/243,575, filed Oct. 1, 2008, entitled “ADAPTIVE TRANSFER EFFICIENCY FEEDBACK AND CONTROL”;

U.S. Pat. No. 5,384,592 to Wong, entitled “METHOD AND APPARATUS FOR TANDEM COLOR REGISTRATION CONTROL.”

### BRIEF DESCRIPTION

The banner (or cover) sheet for a print job may be used for aperiodic sampling of transfer performance and/or fusing performance. Sensing pre-process and/or post-process is required. The resulting sampling is aperiodic and dependent on the job flow. In office products there is typically a frequent generation of cover sheets and the information collected in this way can be useful in system performance optimization. The concept is described for a tandem transfer system.

In accordance with an aspect of the exemplary embodiments, an image processing method is provided. The image processing method includes receiving a print job at an image forming device, generating a banner page for the print job, adding one or more test patterns to the banner page, sensing the test pattern(s) on the banner page pre transfer and/or post-transfer and generating image quality data, analyzing the image quality data for image quality defects, and adjusting at least one transfer and/or fusing setting for the image forming device based on the analysis of the image quality data.

Optionally, the method includes sensing the test patterns on the intermediate transfer belt pre-transfer and/or post transfer and generating additional image quality data to be analyzed or sensing the test patterns on the photoreceptor pre-transfer and/or post transfer and generating additional image quality data to be analyzed.

In accordance with another aspect of the exemplary embodiments, an image processing apparatus is provided. The image processing apparatus includes an image forming device that receives a print job and adds one or more test patterns to a banner page for the print job, at least one sensor that senses the test patterns on the banner page pre-transfer and/or post-transfer and generates image quality data, and an image processing controller that analyzes the data for printing defects and adjusts one or more transfer and/or fusing settings for the image forming device based on the analysis of the image quality data.

Optionally, the apparatus includes sensors for sensing the test patterns on the intermediate transfer belt pre-transfer and/or post transfer and generating additional image quality data to be analyzed or sensing the test patterns on the photoreceptor pre-transfer and/or post transfer and generating additional image quality data to be analyzed.

In accordance with yet another aspect of the exemplary embodiments, a computer program product is provided. The computer program product includes a computer-usable data carrier storing instructions that, when executed by a computing device, cause the computing device to perform a method that includes receiving a print job, generating a banner page for the print job, adding one or more test patterns to the banner page, sensing the banner page pre-transfer and/or post-transfer and generating image quality data, analyzing the image quality data for image quality defects, and adjusting at least one transfer and/or fusing setting based on the analysis of the image quality data.

Optionally, the computer program product includes instructions for sensing the test patterns on the intermediate transfer belt pre-transfer and/or post transfer and generating additional image quality data to be analyzed or sensing the test patterns on the photoreceptor pre-transfer and/or post transfer and generating additional image quality data to be analyzed.

In accordance with yet another aspect of the exemplary embodiments, an alternative image processing method is provided. The method includes receiving a print job at an image forming device, generating a banner page for the print job, adding one or more test patterns to the banner page, sensing the test patterns on the banner page pre-fusing and/or post-fusing and generating image quality data, analyzing the image quality data for image quality defects, and adjusting at least one fusing setting for the image forming device based on the analysis of the image quality data.

### BRIEF DESCRIPTION OF THE DRAWINGS

FIG. 1 is a schematic view of a xerographic apparatus in which embodiments may be employed;

FIG. 2 is a flow diagram outlining an exemplary method of cover sheet-based sampling; and

FIG. 3 illustrates an example of a banner (or cover) sheet with multiple test patterns in accordance with aspects of the exemplary embodiments.

### DETAILED DESCRIPTION

As used herein, “print media” generally refers to a usually flimsy physical sheet of paper, plastic, or other suitable physical print media substrate for images, whether precut or web fed. A “print job” is normally a set of related sheets, usually one or more collated copy sets copied from a set of original document sheets or electronic document page images, from a particular user, or which are otherwise related.

As used herein, the term “data” refers generally to physical signals that indicate or include information. The terms “image” and “page,” as used herein, refer to any image containing any, or all, of one or more halftone images, continuous tone images, line art or other graphics images, and/or any compilation of text, that is capable of being displayed on a display device or output on an image bearing substrate. For example, an image may be a combination of graphics and text that is stored in an image input device. The image may be a series of pixel values denoting the color, intensity, and/or any other known or later developed image property of the particular pixels that make up the image.

Each location in an image may be called a “pixel.” Each pixel has certain pixel values associated with it. Each pixel value is a bit in a “binary form” of an image, or a gray scale value in a “gray-scale form” of an image, or a set of color space coordinates in a “color-coordinate form” of an image. The binary form, gray-scale form, and color-coordinate forms are each a two-dimensional array defining an image. An image can be digital, where the various forms of pixel values (i.e., bit, gray scale value, . . . ) are numerical values, or an image can be physical, such as colorants printed on a page, where pixel values are amounts of colorants at respective pixel locations. An operation typically performs “image processing” when it operates on an item of data that relates to part of an image.

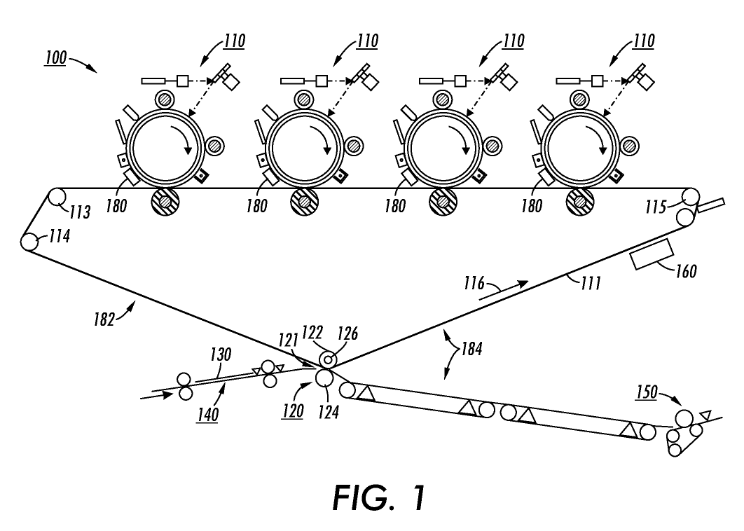

We turn now to the figures, wherein FIG. 1 represents a schematic of an exemplary xerographic printer 100. Although embodiments will be described with reference to the embodiment shown in the drawings, it should be understood that embodiments may be employed in many alternate forms. In addition, any suitable size, shape or type of elements or materials could be used without departing from the spirit of the invention.

As shown in FIG. 1, the xerographic printer 100 may include at least one image forming device 110 that may apply a color of toner (or black). In the example of FIG. 1, there are four image forming devices, or imaging devices, 110 which may apply, for example, cyan, magenta, yellow, and/or black toner. Each image forming apparatus may be equipped with a photoreceptor RMIA sensor 180, such as an extended toner area coverage (ETAC) sensor or an area density coverage (ADC) sensor, or other sensor, capable of providing a measure of toner remaining on the photoreceptor after a toner image transfer from the photoreceptor to an intermediate transfer belt 111 has been performed, but before the photoconductor has been cleaned of excess toner. This sensor may also be used to measure toner on the belt that is not transferred to paper, that is images in the photoreceptor space between customer sheets, and so for this purpose only the sensor can be located prior to transfer.

The intermediate transfer belt 111 may be mounted about at least one tensioning roller 113, steering roller 114, and drive roller 115. As the drive roller 115 rotates, it moves the intermediate transfer belt 111 in the direction of arrow 116 to advance the intermediate transfer belt 111 through the various processing stations disposed about the path of the belt 111. Once the toner image has been completed on the belt 111 by having toner deposited, if appropriate, by each imaging apparatus 110, the complete toner image is moved to the intermediate transfer belt transfer station 120.

The intermediate transfer belt transfer station 120 may transfer the toner image to paper or other print media 130 carried to the transfer station by transport system 140. The media may then pass through a fusing station 150 to fix the toner image on the media 130. Many xerographic printers 100 use at least one biased transfer roller 124 for transferring imaged toner to sheet-type media 130 as shown and according to embodiments, though it should be understood that embodiments can be employed with continuous rolls of media or other forms of media without departing from the broader aspects of embodiments.

As shown in FIG. 1, the intermediate transfer belt transfer station 120 may include at least one backup roller 122 on one side of the intermediate transfer belt 111. The backup roller 122 may form a nip 121 on the belt 111 with a biased transfer roller 124 so that media 130 passes over the transfer roller 124 in close proximity to or in contact with the complete toner image on the intermediate transfer belt 111. The transfer roller 124 may act with the backup roll 122 to transfer the toner image by applying high voltage to the surface of the transfer roller 124, such as with a steel roller. The backup roller 122 may be mounted on a shaft 126 that may be grounded, which creates an electric field that pulls the toner image from the intermediate transfer belt 111 onto the substrate 130. The sheet transport system 140 then directs the media 130 to the fusing station 150 and on to a handling system, catch tray, or the like (not shown).

Alternatively, in embodiments the backup roller 122 may be mounted on a shaft that is biased. As described above, the biased transfer roller 124 may be mounted on a shaft 126 that may be grounded, which creates an electric field that pulls the toner image from the intermediate transfer belt 111 onto the substrate 130. Alternatively, the shaft of the backup roller 122 may be biased while the shaft 126 on the biased transfer roller 124 may be grounded. The sheet transport system 140 may then direct the media 130 to the fusing station 150 and on to a handling system, catch tray, or the like (not shown).

As shown in FIG. 1, intermediate transfer belt 111 may be equipped with an intermediate transfer belt RM/A sensor 160, such as an extended toner area coverage (ETAC) sensor or an area density coverage (ADC) sensor, or other sensor, capable of providing a measure of toner remaining on intermediate transfer belt 111 after a toner image transfer from intermediate transfer belt 111 to paper, or to another intermediate transfer belt, has been performed, but before intermediate transfer belt 111 has been cleaned of excess toner.

Pre and post transfer sensing devices typically utilize light as a stimulus and may operate in either transmission or reflective modes. Measurements are made by the comparison of the amount of light received by a detector with and without image content present. Other potential sensors may utilize light frequency information to directly measure toner mass or color values. This can be done by a sensor such as a spectrophotometer.

The xerographic printer 100 also includes various mechanisms for duplex printing. That is, after the appropriate single color or multicolor image is transferred to the print medium, the medium may be flipped and transferred again to the toner image transfer assembly such that images are produced on both sides of the medium.

Further, sharing of resources has become an integral part of the typical day-to-day business operations scenario. In particular, printers of greater cost and which offer such attributes as higher speed, better resolution or color are shared. However, this means that the printed hardcopy output in the shared resource is often provided in a limited number or even a single output bin. Most printers designed for resource sharing accommodate this problem in a few ways. Typically, the printer will skew or offset entire print jobs from each other. Often a banner (or cover) page is inserted as a separator sheet between the multiple print jobs. Examples of this are found, for example, in U.S. Pat. No. 4,211,483 to Hannigan et al., U.S. Pat. No. 5,316,279 to Corona et al., U.S. Pat. No. 5,547,178 to Costello, and U.S. Pat. No. 5,709,374 to Taylor et al., which are herein incorporated by reference in their entirety for their teachings.

Banner pages have long been associated with print jobs in shared print environments. A banner page is, typically, a printed sheet that separates one print job output from another. For example, a banner page may include the name or some other uniquely identifying feature of the user that submitted the print job, often in an eye-catching format, so that the user can easily find and separate their print job from the other jobs in the printer's output tray.

Traditionally, the use of banner pages has been relatively narrow in scope and purpose, reflecting the capabilities and intended use of the shared printers. For example, one banner page has typically been output on top of (or in association with) each print job submitted. If multiple copies of a particular job are requested, then multiple banner pages may also be produced. Essentially, the only option available has been whether to print the banner page with the job, or not, and even that option is not adjustable by the user because it is pre-designed at the shared print server that spools the print job to the printer.

Thus, for each print job, the xerographic printer 100 outputs a banner sheet in order to provide various types of information such as the title of the output document, the output date and time, the individual who initiated the print job, the difference of the used font, an error in the sheet size, etc. Also, when the printer 100 is powered on or manually set up by the user, a banner sheet may be output.

The description of the exemplary embodiments is illustrated for the case of tandem second transfer. It is to be understood that similar applications exist with fusing. The core idea is to utilize the cover sheet to render test images, sense the images pre and post transfer (fusing), and use the resultant measurement in a feedback context. In this way performance can be periodically measured and feedback adjustments made.

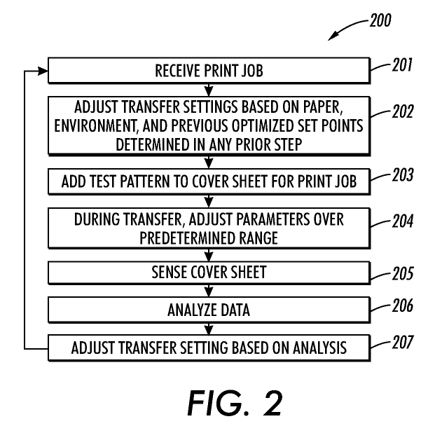

Note that the processing components for the printer 100 may be embodied in a computing device or combination of computing devices, including a personal computer, a laptop computer, a personal digital assistant, or the like, or a dedicated computing device, for example, in the digital front end of the printer 100 or in an optical sensor, in a network server, or the like. The processing components may be in the form of one or more plug-in software components or hardware components. In the illustrated embodiment, the processing components execute instructions for performing some of the steps of the exemplary method described with reference to FIG. 2. These instructions may be stored in memory. While the processing components are described as separate entities it is to be appreciated that two or more of the components may be combined and that the components may be distributed among two or more computing devices.

An exemplary cover sheet-based sampling method 200 is illustrated in FIG. 2. Initially, a print job is sent to the printer 100 (201). At this time, some of the initial transfer (and fusing) settings may be set based on the paper, the environment, and/or previous optimized set points determined in any prior step (202).

Where banner or cover sheets are generated and printed, as is common in an office product, there is an opportunity to periodically render specific patches and record the transfer to paper performance. A banner sheet is an additional separator page that is printed with your jobs. The banner sheet generally includes the printing system device name and a network user name. Banner sheets separate each completed print job in the output bins, making it easier to identify and retrieve a user's documents when they are among documents that have been submitted by other network users.

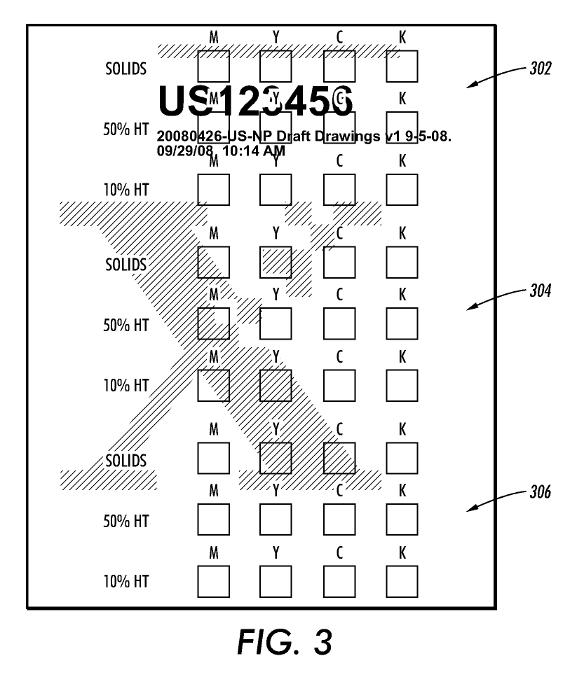

Thus, according to the exemplary method, one or more test patterns (or transfer set points) are added to the banner (or cover) sheet for the print job (203). An example of a banner sheet with three test patterns (302, 304, 306) is shown in FIG. 3. It is to be understood that any number of test patterns may be added to the banner sheet, depending on the size of the sheet.

The printing process is started, and, during transfer, the parameters may be adjusted over a predetermined range about nominal (204). Next, pre-transfer and/or post-transfer sensing of the test patterns, such as test patterns 302, 304 and 306, is performed (205). In a tandem system with an intermediate belt, such as the printer 100 shown in FIG. 1, pre and post first transfer sensing (182, 184, respectively) can occur with the test pattern(s) placed in the inter-document zone of the belt. The idea is to measure what is coming in and then what is coming out. Generally, what comes in is what comes out, but the transfer process is not perfect. What comes in may be measured at the photoreceptor if transfer occurs between the photoreceptor and the paper (where there is no intermediate belt). If there is an intermediate belt 111, then it is possible to measure what comes in at the intermediate belt instead of the photoreceptor. What comes out will be measured on the banner sheet. Note that untransfered mass can also be measured on the intermediate belt after transfer.

Since the first transfer is to an intermediate belt, such as the intermediate transfer belt 111, this method can be useful in inferring transfer performance variation due to material state changes. This is so since the transfer substrate, the intermediate belt, has relatively stable characteristics in comparison to the plethora of paper types a customer may use. Since the transfer substrate is relatively constant, changes in transfer performance can be inferred to be due to changes in the toner material state. However, at the second transfer point, which is the point at which the impact of paper property variation is introduced into the system, transfer variation can be inferred to be due to either the substrate or some interaction between material state and substrate. It is important to therefore measure transfer performance to the actual substrate, i.e. most commonly paper. The cost associated with transferring test patches to a paper sheet is greatly reduced by utilizing the banner sheet.

If running duplex, then the cover sheet before and after the second pass through fusing can also be captured. Even if the job is not duplex, the cover sheet can be run in duplex to assess the presence of paper moisture or obtain more sample points (albeit at two different paper states).

At this point, the defects or performance deficiencies are analyzed and classified (206). Transfer efficiency, or algorithms to detect specific transfer image quality defects (snow, transfer related mottle, plowing, etc.), can then be employed. Transfer systems are such that pre-transfer grid voltages and transfer currents can be altered within the same page. In this way, a full system identification and response experiment, possibly with replicates, can be conducted. For example, a toner mass sensor can identify which parameter setting gives the largest toner mass on the banner sheet and lock into that setting. Additionally, a sensor can capture the transferred image on the banner sheet and look for those settings that give the most uniform transferred image (in other words, no or minimal areas in which there are toner deletions).

Then, based on the measurements, a feedback adjustment with respect to transfer and/or fusing can be made (207). The number of potential actuators and the levels over which they can be manipulated is dependent on paper size, patch sizes, timing, and spatial constraints. By way of example, (a) for residual mass level (most common problem), adjust E, that is the transfer field; (b) for deletions (occasional gaps in paper), adjust pressure; and (c) for lead edge artifacts, adjust timing (d) if toner in background areas is detected, lower the amount of toner in the sump. Other possible adjustments are possible and depend on the latitude of the technology employed.

It is to be appreciated that the sampling scheme may be limited in terms of rate, but it can be engineered as an effective means of feedback compensation for slowly varying disturbances without the associated cost of paper and paper handling techniques.

The method illustrated in FIG. 2 may be implemented in a computer program product that may be executed on a computing device. The computer program product may be a tangible computer-readable recording medium on which a control program is recorded, such as a disk, hard drive, or may be a transmittable carrier wave in which the control program is embodied as a data signal. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. An image processing method comprising:
receiving a print job at an image forming device;
generating a banner page for the print job;
adding one or more test patterns to the banner page;
sensing the test patterns on the banner page pre-transfer and/or post-transfer and generating image quality data;
analyzing the image quality data for image quality defects; and
adjusting at least one transfer setting for the image forming device based on the analysis of the image quality data.

2. The method of claim 1, further comprising:
sensing the test patterns on the intermediate transfer belt pre-transfer and/or post transfer and generating additional image quality data to be analyzed;

3. The method of claim 1, further comprising:
sensing the test patterns on the photoreceptor pre-transfer and/or post transfer and generating additional image quality data to be analyzed.

4. The method of claim 1, wherein the image forming device comprises a xerographic printer.

5. The method of claim 1, wherein the image quality defects include at least one of toner deletions, transfer related mottle, and transfer related image disturbances.

6. The method of claim 5, further comprising:
using a toner mass sensor to identify a parameter setting that gives the largest or proper toner mass on the banner sheet and locking into that parameter setting.

7. The method of claim 1, further comprising:
using a sensor to capture the transferred image on the banner sheet and looking for those transfer settings that give the most desirable transferred image, wherein the transfer settings are dependent on paper size, patch sizes, timing, and spatial constraints.

8. The method of claim 1, further comprising:
adjusting a transfer field to adjust for defects relating to residual mass level;
adjusting pressure to adjust for defects relating to deletions;
adjusting timing to adjust for defects relating to lead edge artifacts;
lowering the amount of toner in the sump if toner in background areas is detected.

9. An image processing apparatus comprising:
an image forming device that receives a print job and adds one or more test patterns to a banner page for the print job;
at least one sensor that senses the test patterns on the photoreceptor, intermediate transfer device, and/or banner page pre-transfer and/or post-transfer and generates image quality data; and
an image processing controller that analyzes the data for printing defects and adjusts at least one transfer setting for the image forming device based on the analysis of the image quality data.

10. The apparatus of claim 9, further comprising:
a sensor that senses the test patterns on the intermediate transfer belt pre-transfer and/or post transfer and generates additional image quality data to be analyzed.

11. The apparatus of claim 9, further comprising:
a sensor that senses the test patterns on the photoreceptor pre-transfer and/or post transfer and generates additional image quality data to be analyzed.

12. The apparatus of claim 9, wherein the image forming device comprises a xerographic printer.

13. The apparatus of claim 9, wherein the image quality defects include at least one of toner deletions, transfer related mottle, and transfer related image disturbances.

14. The apparatus of claim 13, further comprising:
a toner mass sensor that identifies a parameter setting that gives the largest proper toner mass on the banner sheet, wherein the transfer settings are dependent on paper size, patch sizes, timing, and spatial constraints

15. The apparatus of claim 9, wherein the image processing controller is operative to:
adjust a transfer field to adjust for defects relating to residual mass level;
adjust pressure to adjust for defects relating to deletions;
adjust timing to adjust for defects relating to lead edge artifacts;
lower the amount of toner in the sump if toner in background areas is detected.

16. A computer program product comprising:
a computer-usable data carrier storing instructions that, when executed by a computing device, cause the computing device to perform a method comprising:
receiving a print job;
generating a banner page for the print job;
adding one or more test patterns to the banner page;
sensing the test patterns on the banner page pre-transfer and/or post-transfer and generating image quality data;
analyzing the image quality data for image quality defects; and
adjusting at least one transfer and/or fuser setting for the printer based on the analysis of the image quality data.

17. The computer program product of claim 16, wherein the image quality defects include at least one of toner deletions, transfer related mottle, and transfer related image disturbances.

18. The computer program product of claim 16, wherein the method further comprises:
identifying a parameter setting gives the largest or proper toner mass on the banner sheet and locking into that setting based on data from a toner mass sensor.

19. The computer program product of claim 16, wherein the method further comprises:
capturing the transferred image on the banner sheet and looking for those settings that give the most uniform transferred image.

20. The computer program product of claim 16, wherein the transfer settings are dependent on paper size, patch sizes, timing, and spatial constraints.

21. The computer program product of claim 16, wherein the method further comprises:
adjusting a transfer field to adjust for defects relating to residual mass level;
adjusting pressure to adjust for defects relating to deletions;
adjusting timing to adjust for defects relating to lead edge artifacts;
lowering the amount of toner in the sump if toner in background areas is detected.

22. The computer program product of claim 16, wherein the method further comprises:
sensing the test patterns on the intermediate transfer belt pre-transfer and/or post transfer and generating additional image quality data to be analyzed;

23. The computer program product of claim 16, wherein the method further comprises:
sensing the test patterns on the photoreceptor pre-transfer and/or post transfer and generating additional image quality data to be analyzed.

24. An image processing method comprising:
receiving a print job at an image forming device;
generating a banner page for the print job;
adding one or more test patterns to the banner page;
sensing the test patterns on the banner page pre-fusing and/or post-fusing and generating image quality data;
analyzing the image quality data for image quality defects; and
adjusting at least one fusing setting for the image forming device based on the analysis of the image quality data.
